(19) United States
(12) Patent Application Publication
(10) Pub. No.: US 2009/0157844 A1
(43) Pub. Date: Jun. 18, 2009

(54) NETWORK AUTOMATIC DISCOVERY METHOD AND SYSTEM

(75) Inventors: Pietro Fionda, St-Leonard (CA); Nadine Gregoire, Montreal (CA)

Correspondence Address: ERICSSON CANADA INC.;PATENT DEPARTMENT, 8400 DECARIE BLVD., TOWN MOUNT ROYAL, QC, H4P 2N2, CA

(73) Assignee: TELEFONAKTIEBOLAGET LM ERICSSON (PUBL), Stockholm (SE)

(21) Appl. No.: 11/955,840

(22) Filed: Dec. 13, 2007

(51) Int. Cl. G06F 15/16

(52) U.S. Cl. 709/218

(57) ABSTRACT

The network automatic discovery protocol and device enables discovery of the state status information of network community members and detects when other community members enter or leave the community. The protocol maintains a sequence number at each node system that indicates a change in state to other nodes in the community. The protocol also uses a seed list that provides both an initial list of community members to advertise its presence at startup and as a mechanism for recovery when communication is interrupted.

### FIELD OF THE INVENTION

The present invention relates to a method and system for discovering nodes present in a network, and more particularly, to a protocol for automatic discovery of nodes in a network.

### BACKGROUND

Network discovery involves finding out which computers, printers, switches, routers, modems, servers, storage systems or other devices are connected to the network. The discovery process typically involves finding information about devices linked to the network, for example, a device's IP address, its type, and capabilities. Currently, it may be possible to automatically discover some network components using multicast protocol, such as Internet Group Management Protocol (IGMP) between the node system and the external router for group membership discovery. However, multicast protocol is not widely supported through the Internet. To circumvent such shortcomings, some products on the market have their own network automatic discovery mechanisms that are generally based on newcomer nodes obtaining the network topology information from a few server nodes.

In a fairly stable environment, server nodes providing the network topology to newcomer nodes may be sufficient. However, if the availability of those server nodes cannot be guaranteed, the automatic discovery of the network topology is put at risk.

### SUMMARY

A network automatic discovery protocol and device enables discovery network community members and detects when other community members enter or leave the community. The protocol maintains a value, such as a sequence number at each node system, which indicates a change in topology state to other nodes in the community. The protocol also uses a persistent member or seed list to provide both an initial list of community members to advertise or announce its presence at startup and a mechanism for recovery when communication is interrupted. Thus, the network topology information is spread out to all participating node systems. A newcomer node can contact any of those participating node systems to become part of the network, become aware of other participating node systems, and become known to all other nodes.

Various aspects consistent with the subject matter described herein are directed to node discovery in a network performed by each of a plurality of network nodes linked in the network. In one aspect, each of the network nodes maintains a member list containing identifying data of at least a subset of the nodes in the network, such as addresses of the plurality of nodes. In another aspect, each network node also maintains data a value indicating an amount of topology change detected by that node, such as a sequence number or other value. Additionally, each network node maintains an active list, which may contain addresses or other data identifying nodes known to be active network participants.

In another aspect, a network node repeatedly transmits to each address in the member list a presence message that contains an address of the network node and the sequence value, and monitors for presence messages transmitted from at least one or more network nodes located remotely from that network node.

Another aspect involves each network node receiving a presence message from one of the remote network nodes. A presence message may contain an address and/or other identifying data for that remote network node and a data value or sequence value of the remote network node, and determining whether the address and/or other identifying data of the remote network node is stored in the active list of the network node.

In yet other aspects, when a network node receives a presence message from a remote network node, the received data value indicating an amount of detected topology change may cause the network node to update data structures maintained at the network node. For instance, if the received data value is equal to a predetermined initial value and the remote node identifying data is not stored in the active list maintained at the network node, the address and/or identifying data of the remote network node is added to the active list of the network node, the data value is adjusted, for example, incremented, to indicate a topology change, and a presence message containing the adjusted data value is provided to the remote network node. If the data value indicates a greater or equal amount of detected topology change than that of the remote network node, and the remote network node identifying data is not stored in the active list of the network node, the identifying data of the remote network node is added the to the active list. If the sequence value indicates a lesser amount of detected topology change than the data value of the remote network node, the data value of the network node is set equal to the remote network node data value, a request is sent to the remote network node for content contained in its active list, and the active list of the network node is updated with the content.

It should be emphasized that the terms “comprises” and “comprising,” when used in this specification, are taken to specify the presence of stated features, integers, steps or components; but the use of these terms does not preclude the presence or addition of one or more other features, integers, steps, components or groups thereof.

It is to be understood that both the foregoing general description and the following detailed description are exemplary and exemplary only and are not restrictive of the invention, as claimed.

### BRIEF DESCRIPTION OF THE DRAWINGS

The accompanying drawings, which are included to provide a further understanding of the invention and are incorporated in and constitute a part of this specification, illustrate embodiments of the invention that together with the description serve to explain the principles of the invention. In the drawings:

FIG. 1 is a diagram of a community of nodes in accordance with an exemplary embodiment.

FIG. 2 is a block diagram representing an exemplary discovery protocol of a network node system including program modules and data structures and timers/counters.

FIG. 3 is a flowchart of an exemplary startup/restart procedure in accordance with some embodiments.

FIG. 4 is a flowchart of an exemplary procedure performed after receiving a Keep Alive message in accordance with some embodiments.

FIG. 5 is a flowchart of an exemplary procedure performed after receiving a response to an IP address request message in accordance with some embodiments.

FIG. 6 is a flowchart of an exemplary procedure performed after detecting a timeout of a T_{purgeconfig} timer in accordance with some embodiments.

FIG. 7 is a time chart illustrating discovery of node systems after concurrent startup in accordance with exemplary embodiments.

FIG. 8 is a time chart illustrating discovery of a node entering a network community in accordance with exemplary embodiments.

FIG. 9 is a time chart illustrating discovery of a node leaving a network community in accordance with exemplary embodiments.

FIG. 10 is a time chart illustrating an exemplary scenario in which concurrent T_{purgeconfig} timeouts for a same node are detected by two node systems.

FIG. 11 is a time chart illustrating an exemplary scenario in which concurrent T_{purgeconfig} timeouts for different nodes are detected by two node systems.

FIG. 12a is a time chart illustrating discovery in an exemplary scenario in which an inter-router link connecting node groups goes down.

FIG. 12b is a time chart illustrating discovery in an exemplary scenario in which the inter-router link of FIG. 12a is restored.

### DETAILED DESCRIPTION

The various features of the invention will now be described with reference to the figures. These various aspects are described hereafter in greater detail in connection with a number of exemplary embodiments to facilitate an understanding of the invention, but should not be construed as limited to these embodiments. Rather, these embodiments are provided so that the disclosure will be thorough and complete, and will fully convey the scope of the invention to those skilled in the art.

Many aspects of the invention are described in terms of sequences of actions to be performed by elements of a computer system or other hardware capable of executing programmed instructions. It will be recognized that in each of the embodiments, the various actions could be performed by specialized circuits (e.g., discrete logic gates interconnected to perform a specialized function), by program instructions, such as program modules, being executed by one or more processors, or by a combination of both. Moreover, the invention can additionally be considered to be embodied entirely within any form of computer readable carrier, such as solid-state memory, magnetic disk, and optical disk containing an appropriate set of computer instructions, such as program modules, and data structures that would cause a processor to carry out the techniques described herein. A computer-readable medium would include the following: an electrical connection having one or more wires, magnetic disk storage, magnetic cassettes, magnetic tape or other magnetic storage devices, a portable computer diskette, a random access memory (RAM), a read-only memory (ROM), an erasable programmable read-only memory (EPROM or Flash memory), an optical fiber, and a portable compact disc read-only memory (CD-ROM), or any other medium capable of storing information. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. Thus, the various aspects of the invention may be embodied in many different forms, and all such forms are contemplated to be within the scope of the invention.

A network can be considered as a collection of linked devices called nodes, each of which is connected to at least one other node. For example, a node may include a switching device having wired, optical and/or wireless connections. A node may be a router or switch handling packet streams, a combination router-switch handling connections and packet traffic, a bridge or a hub. A node also may include a personal computer (PC), personal digital assistant, cell phone, set top box, server computer, hand-held device, laptop device, multiprocessor system, microprocessor-based system, programmable consumer electronics, network PC, minicomputer, mainframe computer, printer, scanner, camera, or other general purpose or application specific device. A node may support a large number of information sources and receivers that dynamically exchange information, or have fixed source/receiving roles, of varying activity. For instance, a node in some embodiments may comprise a system in a local area network (LAN) and/or a wireless LAN (WLAN), a system in an enterprise network, a system connected to a WAN via a gateway, a system providing subscribers operating user equipment (e.g., a mobile or fixed communication device) access to any of several networks (e.g., PSTN, IP WAN, ISDN), or combinations thereof.

Nodes may form a smaller network within a larger network. For example, node systems may be added to form an autonomous network, called a “community,” with IP-based interconnectivity. Alternatively, a community may include most or all nodes communicating in a network. A community may operate in a dynamic environment in which individual node devices or systems join or leave the community at any time and physical proximity between them may be fixed, or change intermittently or continuously. Inter-device protocol runs on each node system to disseminate information about the node systems throughout the community and enable the nodes to automatically discover one another.

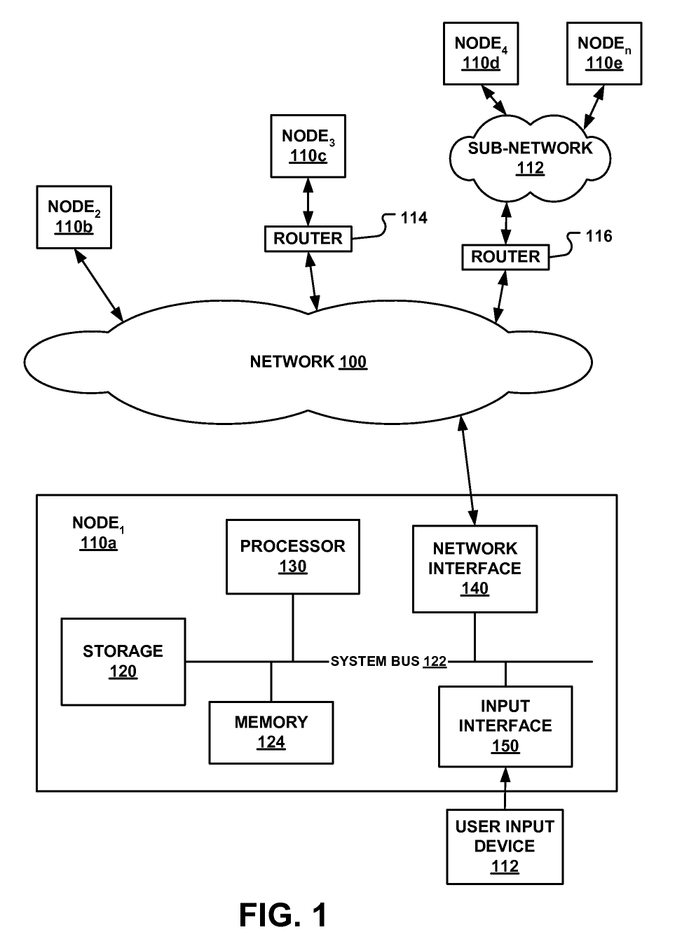

FIG. 1 shows an exemplary network 100 including a community of nodes consistent with some embodiments. While FIG. 1 shows five nodes Node₁ 110a, Node₂ 110b, Node₃ 110c, Node₄ 110d, and Nodeₙ 110e to explain some exemplary embodiments, it should be appreciated that a fewer number nodes (e.g., two or one) or a greater number of nodes may be present or operating at any instant in time. Furthermore, it should be understood that the network shown in FIG. 1 is only one example of a network configuration, and thus any practical number and combination of nodes, sub-networks and linking elements, such as hubs, switches, bridges or routers, may be present in a given implementation. For example, a node system also may form part of a one or more sub-network 112 of nodes connectable to the network 100 by way of an intermediate device. In some embodiments, a single node, such as Node₃, may connect to the network via a router 114, and multiple nodes, such as Node₄ 110d and Nodeₙ 110e may be connected to the network 100 via a router 116, although other intermediate devices may be used, such as a modem, hub, switch, bridge, a router/bridge combination or router/switch combination.

The network 100 may be a local area network (LAN), a wireless local area network (WLAN), a combination of a LAN and WLAN, a wide area network (WAN), a virtual network or other types of networks. For example, the network 100 and sub-network 112 may implement Ethernet protocol (e.g., the IEEE 802.3 standard), one of the IEEE 802.11 standards, combinations of IEEE 802.x standards, an IP-based network (e.g., an IPv4 and IPv6 Internet or intranet, or other type of data packet network (PDN)), and other types and/or combinations of networks. For example, the sub-network 112 may be an Ethernet layer 2 network and router 116 may be a layer 3 device terminating the layer 2 protocol of the sub-network. In some embodiments, each node system Node₁ 110a, Node₂ 110b, Node₃ 110c, Node₄ 110d, and Nodeₙ 110e may be identified by a unique address, such as an IP address, although nodes in some network implementations may use other types of addresses and protocols, such as a MAC address.

As shown in FIG. 1, the network 100 provides interconnectivity between Node₁ 110a, Node₂ 110b, Node₃ 110c, Node₄ 110d and Nodeₙ 110e, although communication between Node₄ 110d, and Nodeₙ 110e may be carried out only within sub-network 112. Each node also may provide connectivity to one or more other networks, such as a PSTN and ISDN (not shown). Furthermore, each of the routers 114 and 116, as well as any other switch, bridge or hub that may be present in the network 100 and sub-network 112 may be considered node systems within the context of the present invention. The individual node systems, for example, any one of Node₁ 110a, Node₂ 110b, Node₃ 110c, Node₄ 110d and Nodeₙ 110e, may be added to the network 100 in an ad-hoc manner to form a community, for example, with IP-based interconnectivity.

FIG. 1 shows components of exemplary Node₁ 110a system in greater detail. The Node₁ 110a system includes storage 120, memory 124, a processor 130, a system bus 122 that couples various node system components to the processor 130, a network interface 140, and an input interface 150. It should be appreciated that the various nodes connectable to a community in the network at any moment in time may have different underlying architectures, but are capable of storing the discovery program modules, data structures and timers/counters described herein and executing these program modules. For example, the Node₁ 110a system may be a PC, while the Node₂ 110b system may be another application(s) specific device (e.g., a printer, scanner, set top box, soft phone, network PC, device providing radio access network and/or core network functionality, switch, hub, router etc.).

Furthermore, a node may include several modules, such as subsystems implemented on a number of general-purpose or application specific boards, which communicate with one another and with other nodes connected to the network. For example, such modules or subsystems may be interconnected in a LAN configuration, for example, and may include more than one I/O port.

The storage 120 is typically non-volatile (i.e., persistent) computer storage media that may include, but is not limited to, magnetic disk storage, magnetic cassettes, magnetic tape or other magnetic storage devices, ROM, CD-ROM, digital versatile disks (DVD) or other optical disk storage, EPROM, EEPROM flash memory and/or any other medium which may be used to store the desired information and which may accessed by the Node₁ 110a system. Memory 122 is typically volatile memory located on or near the processor (e.g., on the processor board) and may replicate all or parts of the data and/or program modules stored in non-volatile memory to enable fast memory access. Volatile memory includes, but is not limited to RAM, static RAM (SRAM), or other volatile memory technology. The storage 120 and or memory 122 may include data and/or program modules that are executable by the processor 130. If a network node is part of a distributive processing environment, storage 120 may include program modules located in local and/or remote computer storage media including memory storage devices.

The network interface 140 may be a network card or adaptor to provide the Node₁ 110a system a way to connect and communicate over the network, for example, a LAN. Alternatively, the Node₁ 110a system may include a router and/or modem to connect to network 100, for example, if the network were an IP-based WAN, through the network interface 140 and a router, or through an internally or externally provided modem (not shown).

In some embodiments the input interface 150, which may or may not be included with other node systems in the network 100, allows users to interact with the Node₁ 110a system through a user input device 112. In some embodiments, user input devices may include a keyboard, mouse or other pointing device, microphone, touch display screen, or other activation or input devices known in the art.

In other embodiments, the input interface 150 may include at least one Node B (or radio base station (RBS)) controlled by a radio network controller (RNC) that allow a user input device 112, such as a mobile terminal, to communicate with other mobile terminals or network nodes, such as with Node₁ 110a or any of remote Node₂ 110b, Node₃ 110c, Node₄ 110d and Nodeₙ 110e, or other user devices connecting though those remote nodes. For example, nodes on network 100 may comprise a UMTS system supporting circuit-switched and packet-switched calls, short messages, voice mails and group calls. It may provide all these services to mobile terminals in its own radio coverage area (e.g., via a radio network subsystem (RNS) or base station subsystem (BSS)) even if it has no connectivity to an IP WAN or the PSTN. Each system also may connect to the external IP WAN implementation of network 100 and support terminal-to-terminal traffic and terminal to the trusted PSTN calls (and vice versa) among the nodes.

The term “local” is used herein in the context of a network node system (or “node”) currently being considered, as opposed to the other “remote” nodes in a community. For example, in the following description, a local node is the node executing one or more program modules or routines, and maintaining data structures, timers/counters etc. associated with that node. Thus, any node system in the community may be considered a “local” network node system in the context of “this node,” while node systems at locations in the network other than the local node are considered “remote.” However, it is to be understood that a local node may store data structures, keep timers/counters etc. relating to one or more remote nodes.

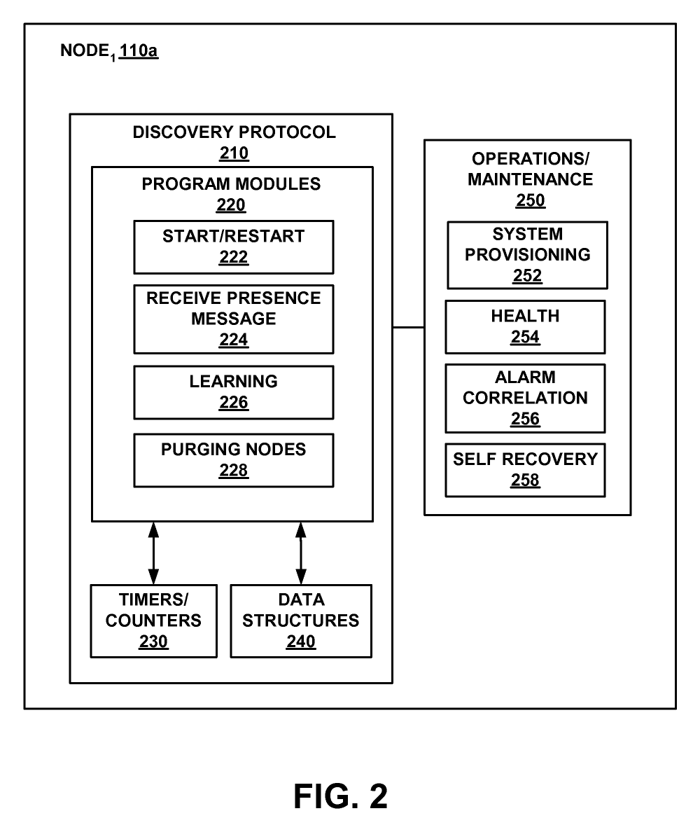

FIG. 2 represents an exemplary discovery protocol 210 including program modules 220 stored in storage 120 and/or memory 122 of a node system. Each node system forming or participating in a community includes the program modules 220 stored in its memory 124 and/or storage 120 to perform the discovery protocol 210. The program modules make use of timers/counters 230 and data structures 240 to perform discovery and discovery updates of nodes present on the network 100.

A node system in accordance with some embodiments also may include an operating system program, or another subsystem or program controlling the discovery protocol. For example, FIG. 2 shows an Operations and Maintenance (O&M) function 250 having modules for system provisioning 252, health monitoring 254, alarm correlation 256 and self-recovery 258. The O&M function may be integrated with the discovery protocol 210 to implement community features. For example, the O&M function 250 may control central O&M hardware managing the entire system and/or control several localized functions on various system components. The O&M may control the entire system and present a simplified and integrated management view of the system to an operator. An operator does not necessarily have to configure each component of an individual node's system to bring the system into service.

In some embodiments, an O&M function 250 may keep components of a standard core network oblivious of the special features of a node system. For example, a node system may include a home location register (HLR) and each HLR is kept unaware of the fact that its contents are replicated in all the node systems in the community. Actions of the O&M function 250 may be used to extract the HLR contents, distribute them, and add profiles learned from other systems. The HLR would not distinguish these software-initiated actions from operator-initiated actions.

The discovery protocol 210 enables the nodes 110a-110d to automatically discover one another in a network a with limited initial configuration data. The discovery protocol includes a start/restart module 222, a receive presence message module 224, a learning module 226, and a Purging Nodes module 228. The discovery protocol modules 220 make use of data structures 240, such as a plurality of lists, and a plurality of timers and/or counters 230. Exemplary discovery protocol data structures 240 and timers/counters 230 will now be described.

Presence Message

Each node in the community is configured to periodically provide a message, for example, a “Keep Alive” (KA) message to other nodes at locations (e.g., preconfigured addresses kept in storage) to announce its presence to those other nodes and/or to provide an indication or notification that the sending node remains active in the community. The presence message also may include a data structure that indicates an amount of topology change detected by a sending node, which may be used by a receiving node to discover and/or resolve differences in community node awareness between these nodes.

Seed List

The seed list (SL) is a data structure stored in persistent memory and read at startup or restart of each node system. It may be utilized by the discovery protocol 210, for example, in the start/restart program module 222 to initiate sending a Keep Alive (KA) message advertising its presence to other network nodes. The SL of a node system may be configured to contain a predetermined list of IP addresses, which may be modified or reconfigured to reflect changes to an expected community or redeployment of the node system to a different network. A SL may include only a subset of the intended community, and the choice of seeds (i.e., addresses) may be designated as desired by the user. For example, a simple seeding algorithm may provide a Node n with (n+1)MOD(number of nodes) and (n+2)MOD(number of nodes) seed addresses. The SL also may provide addresses to a broadcast list, for example, the Community Broadcast List (CBL) described later, which identifies nodes to which KA messages are sent on a continuing basis after startup or restart.

Candidate Deletion List

Each node also stores a Candidate Deletion List (CDL) 122 that may include IP addresses and/or other node-identifying data. The CDL 122 is updated when a local node system learns an IPL from a remote node system, and certain IP addresses of the remote node system are not present in the IPL of the local node system. In this manner, KA messages may still be sent to the remote node system. The CDL 122 also may be updated when a local node system detects a remote node system leaving the community.

Active List

An “active node list” or “active address list” is an exemplary data structure kept at each node system and contains addresses and/or other identifying information of nodes that currently are considered active participants in a community. For example, in some embodiments, addresses may be stored in an active address list and correspond to connected nodes. An active address list may be updated when a local node system detects a remote node system entering the community, leaving the community, or when it learns an active address list of a remote node system. Each node system initially may have an empty active address list.

In accordance with exemplary embodiments described herein, an “IPL” is an active address list that stores Internet Protocol (IP) addresses, although other types of addresses may be stored in an active address list. The content of each node's IPL is, by the nature of the discovery protocol, mutually exclusive from its CDL, and a local node learns only the IPL (i.e., not the CDL) from remote node systems.

Community Broadcast List

Each node in a community stores a Community Broadcast List (CBL) of IP addresses, which is used to notify the presence of a local node system to one or more remote node systems by sending a KA(n) message to each node in the list. Each KA(n) message carries a sequence number an IP sequence number, IP_SQN=n, which is used to detect whether a change has occurred in the community. The IPL, CDL, and elements of the SL not listed in the IPL and CDL, make up the CBL.

IP Sequence Number

As mentioned above, each node system may include a data structure called a sequence number, IP_SQN, which is used to detect whether there has been a change in the node community. In some embodiments, each node begins (e.g., at startup or restart) with an initial IP_SQN value, which may be zero, for example, and a detected change in the topology (e.g., a node leaving or entering the community) will cause this value to change (e.g., increment). For example, after startup or restart, nodes begin sending a Keep Alive message, KA(n), which includes the sequence number IP_SQN=n, where n=0, to each node address in its CBL. A local node that receives a KA(0) presence message from a remote “unknown” node (i.e., a node not listed in the IPL of the local node) adds the remote node's address to its IPL, steps its sequence number n to IP_SQN=n+1, and replies to the remote node, the reply carrying the stepped sequence number. Upon receiving the reply, the remote node realizes that the sequence number is higher than its own sequence number value, so it stores the stepped sequence number as its own sequence number and asks the local node for its complete IPL. The local node replies and the remote node stores, in its own IP list, the local node's address and the IPL of the local node (it would not be necessary to store the remote node's own address if it is present in the IPL received from the local node system). All nodes may exchange information in this manner. When all the community nodes have discovered each other, the sequence numbers of the nodes reach a common stable value, and the nodes maintain this equilibrium (i.e., synchronization) until a change occurs in the community.

On a continuing basis, a non-initial valued IP_SQN contained in a KA message received at a local node from a remote node is compared with the local node's IP_SQN. The result of the comparison leads to two general cases:

1. If the comparison determines that the sequence numbers IP_SQN of the local and remote nodes are stable (i.e., equal) or the local sequence number has a value greater than the value of the remote node sequence number, and the remote node's address is not present in the local node's IPL, the address of the remote node is added to the local node's IPL and the local sequence number may be incremented. If the remote node address is present in the local node's IPL, no change to the local node's IPL would be made.

2. If the comparison determines that the sequence number of the local node is less than that of the remote node, the sequence number of the local node is set equal to the larger remote sequence number and the local node system initiates a “learn” procedure in which a request message, IPReq, is sent from the local node to the remote node requesting the IPL of the remote node. The remote node responds with a response message, IPRsp, which contains the IPL information of the remote node. After receiving IPRsp, the local node updates its IPL with information of the remote IPL.

Keep Alive Timer: T_{KeepAlive}

The KA (presence) messages continue being sent from each node to every node in its CBL at regular intervals defined by a T_{KeepAlive} timer.

Deletion Timer: T_{purgeconfig}

Each node in the community has a deletion timer, T_{purgeconfig}, for other nodes in the community that have an address entry in the node's CCT. T_{purgeconfig} is restarted every time a presence message (i.e., KA) is received, for which there is an entry in the CCT. When a T_{purgeconfig} timer of a local node times out, the remote node associated with that timer is removed from the local node's IPL. Referring again to FIG. 1, for example, if Node₁ 110a is running a T_{purgeconfig} timer for Node₂ 110b, and Node₁ 110a does not receive any presence message from Node₂ 110b before the T_{purgeconfig} timer associated with Node₂ 110b times out, Node₁ 110a deletes Node₂ 110b from its IPL and increments its sequence number, IP_SQN. Because Node₁ 110a has increased its IP_SQN, after it sends the next KA messages to all its neighbors, the receiving neighbor nodes will invoke the learn procedure and request the IPL from Node₁ 110a.

During a learn procedure, the receiving nodes (e.g., Node₃ 110c and Node₄ 110d) may move the address of Node₂ 110b to their CDL as candidate for deletion until it is removed from their CDLs when their own respective deletion timer T_{purgeconfig} for Node₂ 110b times out. If, however, a node (e.g., Node₃ 110c or Node₄ 110d) receives a presence message from Node₂ 110b (e.g., if Node₂ 110b was only unreachable for a brief moment), that receiving node will move the address of the corresponding node from its CDL back to its IPL. After additional KA presence messages are exchanged, the Node₂ 110b would realize its IP_SQN is less than other nodes, which will cause Node₂ 110b to update its own IP_SQN and initiate a leaning procedure to fetch the IPL from a node sending the presence message.

Community Configuration Table

The CCT maintains the membership list in each local node system and includes addresses of remote node systems from which the local node received a Keep Alive message. The CCT list may be updated when receiving a Keep Alive from a remote node not present on the list. The CCT thus represents the T_{purgeconfig} timers running for each remote node from which it received a Keep Alive. The CCT may be stored in persistent storage memory such that it is maintained during times the device is powered down or otherwise off-line.

The following items outline aspects of auto-discovery in the community according to some embodiments:

1. Each node entering a community is seeded with a number of known remote nodes addresses in its SL.

2. Each nodes starts with IP_SQN=0 when it enters or restarts, although any incrementable value may be designated as the initialization/restart sequence number.

3. A remote node receiving a KA(0) must immediately reply with its current IP_SQN; all other KA messages are sent periodically via the T_{KeepAlive} timer.

4. Under the following conditions, a given node increments its IP_SQN:
a. Upon reception of KA(0).
b. Timeout of the T_{purgeconfig} timer if the corresponding remote node was in the IPL_{local}.
c. Upon reception of a Keep Alive message from a remote node with IP_SQN equal to its own IP_SQN but the remote node system is not in the CBL of the given node system.
d. When the IP address of a given node is moved from CDL to IPL.

5. If the IP_SQN from the remote node is greater than that of the local node, the local node initiates learning of the IPL towards the remote node via IPReq/Rsp messages.

6. If the IP-SQN from both remote and local node systems are equal at a given KA reception and the remote node system is not in the IPL of the local node system, the local node system adds this IP address in the IPL and increments its IP_SQN.

7. If the IP_SQN from the remote node is less than that of the local node and the remote node is not in the IPL of the local node system, the local node adds this IP address in the IPL, but does not increment its IP_SQN. At the next T_{KeepAlive} timeout, the remote node will initiate learning of the IPL.

8. Each Node in the community must repeatedly send a KA message to all members in the SL with the current IP_SQN in addition to those in the BL for the life of the node system.

With this background, the program modules 220 of the discovery protocol 210 of FIG. 2 are now explained in detail.

Start/Restart

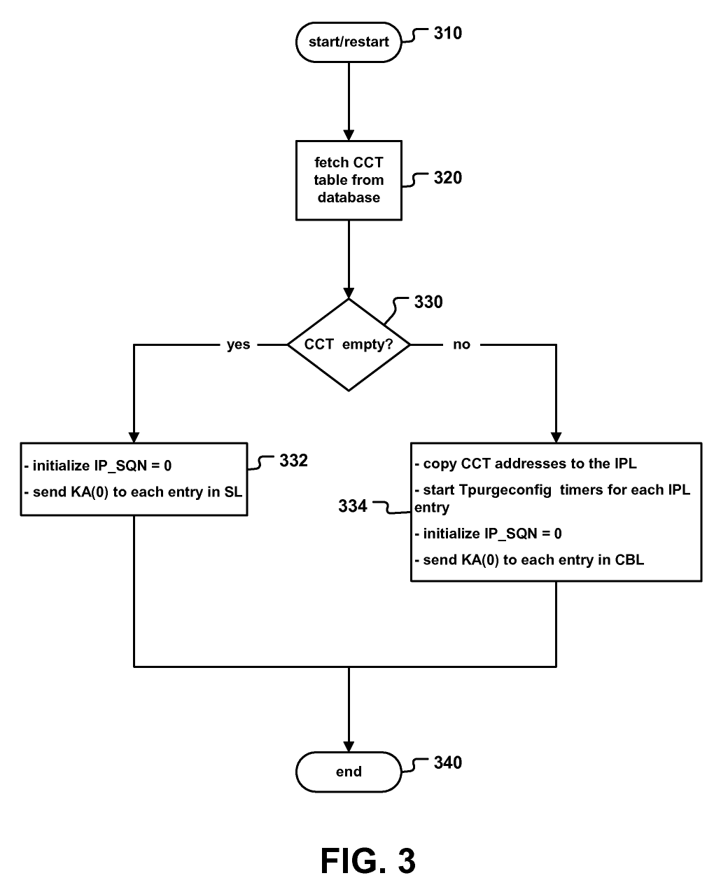

FIG. 3 illustrates an exemplary Start/Restart process performed in some embodiments when a node system is first started up or is restarted. As shown in FIG. 3, after powering up or restarting a node device in process 310, process 320 fetches the Community Configuration Table (CCT) from persistent memory of the node.

In process 330, it is determined whether the fetched CCT is empty or not. If the CCT is empty, the “yes” path is followed to process 332, which initializes IP_SQN=0, and sends a Keep Alive message (KA(0)) to each entry in the SL. If the CCT is not empty, the “no” path is taken to process 334, which copies the CCT addresses to the IPL, starts the T_{purgeconfig} timers for each IPL entry, sets IP_SQN to a initial value (e.g., zero), and sends a Keep Alive message (KA(0)) to each entry in the CBL.

Receive Presence Message

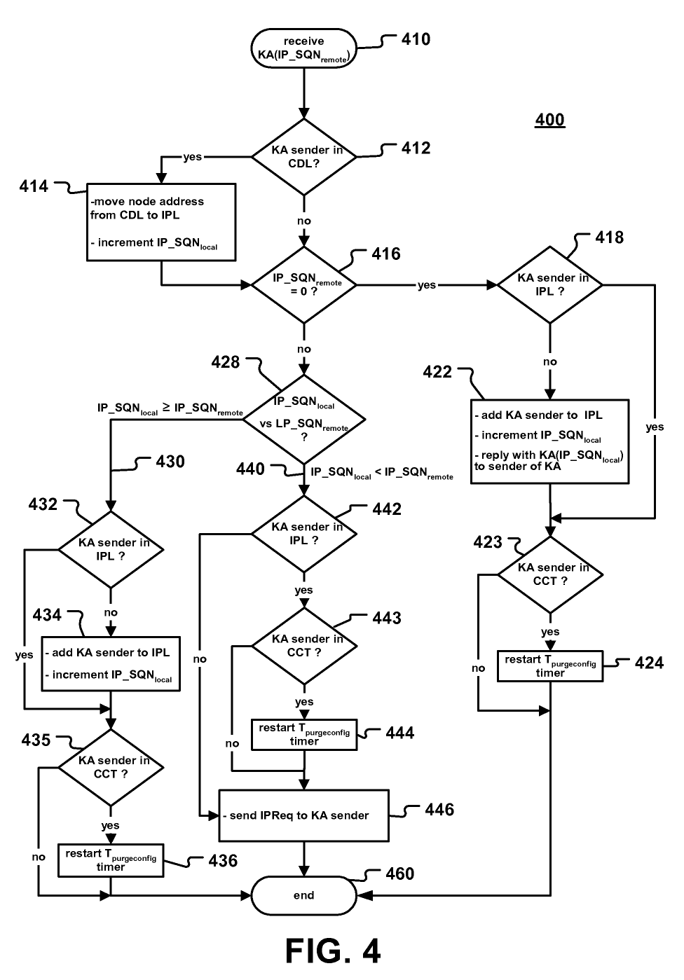

FIG. 4 is a flowchart showing exemplary receive KA procedure 400 performed by a node system upon receipt of a KA message. Procedure 400 starts at process 410 in which a local node receives from a remote node a Keep Alive message KA(IP_SQNᵣₑₘₒₜₑ), which includes the remote node's sequence number. Next, in process 412 the local node checks whether the IP address of the KA sender is in the CDL of the local node. If the sending node's IP address is present in the CDL, the “yes” path is taken to process 414, which moves the node address from the CDL to the IPL and increments IP_SQN_{local}, and thereafter the procedure 400 advances to process 416. If it is determined in decision 412 that the address of the sender is not present in the CDL of local node, the “no” path is taken from decision 412 directly to process 416.

Process 416 determines whether the received IP_SQN of the remote node is equal to a predetermined initial value (e.g., zero). If it is, then the “yes” path is taken from decision 416 to process 418 where it is determined whether the IP address of the KA sending node (i.e., the remote node) is in the IPL of the local node. If it is, the “yes” path is taken to decision 424, which determines whether to restart the T_{purgeconfig} timer associated with the KA sender. If the address of the sender is not in the IPL of the local node, the “no” path is taken to process 422, which adds the KA sender address to the IPL, increments IP_SQN_{local}, and replies to the sending node with KA(IP_SQN_{local}). Next, at decision 423, it is determined whether the KA sender's address is in the CCT. If it is, the T_{purgeconfig} timer associated with the KA sender is restarted in process 424 and the receive KA procedure 400 ends at 460. If the decision 423 determines that the address of the KA sender is not in the CCT, the procedure 400 ends without restarting the T_{purgeconfig} timer associated with the KA sender.

If process 416 determines that the remote node sequence number IP_SQNᵣₑₘₒₜₑ is not equal to zero, the “no” path is taken to process 428 where the sequence number of the local node is compared with the sequence number of the remote node. If IP_SQN_{local} is greater than or equal to IP_SQNᵣₑₘₒₜₑ, path 430 is taken to process 432, which determines whether the address of the KA sender (i.e., the remote node) is stored in the IPL of the local node. If not, the “no” path is taken to process 434, which adds the address of the remote KA sender to the IPL of the local node and increments IP_SQN_{local} (see item 6 above). Next, if the address of the remote node is present in the local node's IPL, process 434 is skipped, and at decision 435 it is determined whether the KA sender's address is in the CCT. If it is, the T_{purgeconfig} timer associated with the KA sender is restarted in process 436 and the receive KA procedure 400 ends at 460. If the KA sender's address is absent from the CCT, the process 436 of restarting the T_{purgeconfig} timer is not performed, and procedure 400 ends.

If process 428 determines that IP_SQN_{local} is less than IP_SQNᵣₑₘₒₜₑ, path 440 is taken to decision block 442, which determines whether the IP address of the KA sender (i.e., the remote node) is in the IPL of the local node. If it is, the “yes” path is taken in which decision 443 determines whether the KA sender address is in the CCT. If it is, the T_{purgeconfig} timer is restarted, process 446 sends an IPReq message to the remote node (see item 5 above) to initiate a “learn” process by the local node of the remote node's IPL, and the receive KA procedure 400 ends at 460. If the KA sender's address is not in the CCT, process 444 is not performed before sending the IPRsp in process 446 and ending the procedure.

Learning

In the learning process, such as when a local node system receives a Keep Alive (KA) message sent by a remote node system and the KA includes an IP_SQNᵣₑₘₒₜₑ greater than the IP_SQN_{local}, the local node sends an IPReq message to the remote node requesting the IPL from the remote node system. In response to the request, the remote node system returns an IPRsp message including the IPL information.

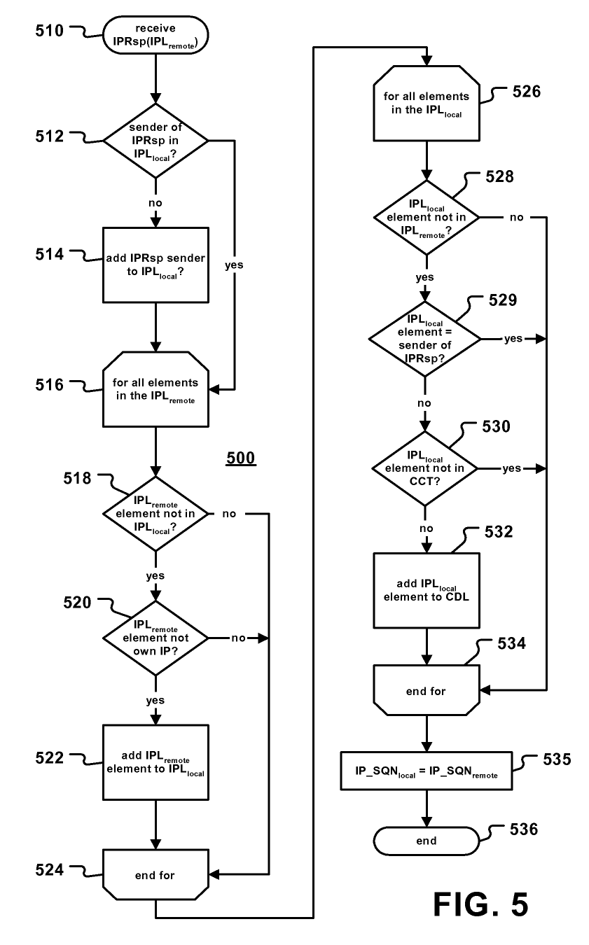

FIG. 5 illustrates an exemplary receive IPRsp procedure 500, which is part of a learning procedure performed in some embodiments by a local node system after receiving from a remote node system an IPRsp message in response to an IPReq message. Procedure 500 begins at process 510 after the requesting node receives a response message IPRsp(IPLᵣₑₘₒₜₑ), which contains the remote node's IPL, from the remote node. Next, the local node determines, in process 512, whether the address of the sender is in the local node's IPL (IPL_{local}). If the sender's address is not stored in the IPL_{local}, the “no” path is taken to process 514, which adds the address of the remote node to the IPL_{local}.

After either determining that the IPL_{local}, already stores the remote node's address in process 512 or adding the remote node's address to the IPL_{local} in process 514, procedure 500 executes a loop at 516-524 that examines each of the address elements of the received IPLᵣₑₘₒₜₑ. For each of the IP address elements, if decision 518 determines that element is not in the IPL_{local}, and procedure 520 determines the address is not that of the local node system, process 522 adds the address element to the IPL_{local}.

After completing the loop of processes 516-524, a second loop is performed by processes 526-536 for each element stored in the IPL_{local}. Decision 528 identifies which elements stored in the IPL_{local} are not stored in the IPLᵣₑₘₒₜₑ. If an IPL_{local} element under consideration also is in the IPLᵣₑₘₒₜₑ, the “no” path is taken and the loop process continues to the next element. If decision 528 determines the IPL_{local} address elements is not in the IPLᵣₑₘₒₜₑ, the “yes” path is taken to decision 529, which determines whether the IPL_{local} element under consideration is the same as an element of the IPRsp sender. If it is, the “yes” path is taken and the loop proceeds to the next IPL_{local} address element. If decision 529 determines the addresses are different from one another, the procedure advances along the “no” path to decision 530, which determine whether the IPL_{local} element is stored in the CCT. In process 532, elements of the IPL_{local} that are not in the IPLᵣₑₘₒₜₑ, but that are stored in the CCT, are added to the CDL. When loop 526-534 processes all the addresses stored in the IPL_{local}, process 535 sets the IP_SQN_{local} value equal to the value of the IP_SQNᵣₑₘₒₜₑ and procedure 500 terminates at 536.

Purging Nodes

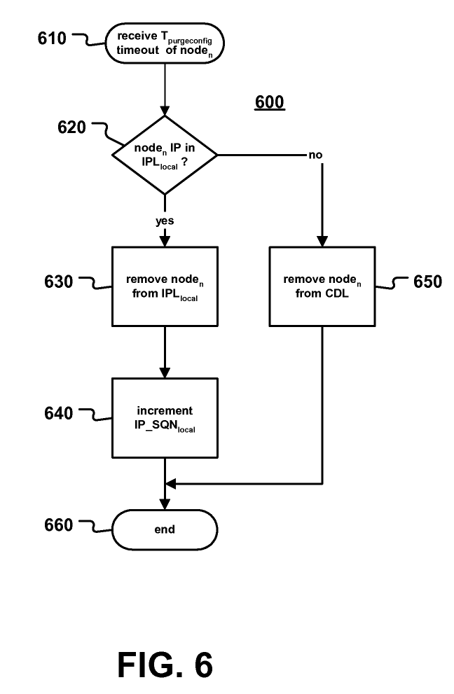

FIG. 6 illustrates a procedure 600 that may be performed locally at each node system when it receives a T_{purgeconfig} timer timeout of a node presently stored in either the IPL_{local} or the CDL of that node. The procedure 600 starts at process 610 when the local node receives or detects a timeout of a T_{purgeconfig} timer associated with a nodeₙ being monitored by the local node. Next, in process 620 the local node determines whether the IP address of nodeₙ is in the IPL_{local}. If it is, the “yes” path is taken from process 620 and the IP address of the nodeₙ is removed from the IPL_{local} in process 630. Thereafter, the local node increments its IP_SQN and the procedure 600 ends at 660. If process 620 determines that the IP address of the nodeₙ is not in the IPL_{local}, the procedure takes the “no” path from process 620 to the process 650, which removes the IP address of the nodeₙ from the CDL of the local node, and procedure 600 terminates at 660.

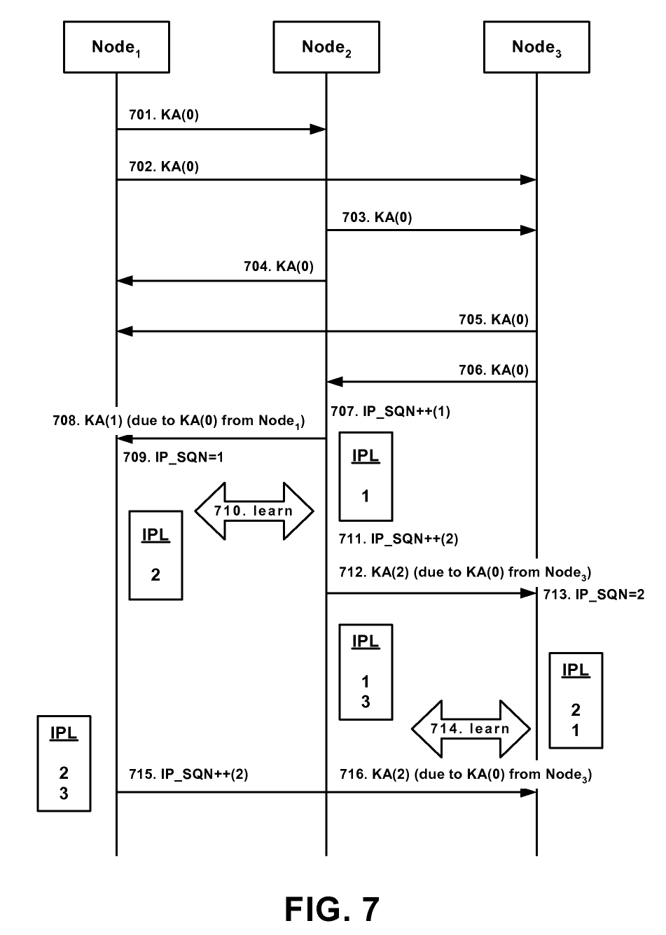

FIGS. 7-12b illustrate exemplary scenarios related to the node behavior and discovery when initially forming a community, when detecting one or more node systems joining an existing community, and when detecting one or more node system leaving an existing community.

Initial Community Formation

FIG. 7 shows an exemplary process of automatic node discovery during community formation. Starting from the top of FIG. 7, the Node₁, Node₂ and Node₃ systems are powered up concurrently or in a quasi-simultaneous manner. All nodes Node₁, Node₂ and Node₃ have been configured and are ready to provide network services. In the following, an IP address is represented as an integer identifying a particular node for brevity, and “++(n)” represents an increment of an IP_SQN to the value n.

701-706: Each of the nodes Node₁, Node₂ and Node₃ begins transmitting initial Keep Alive messages (KA(0)) to the other nodes. For example, the SL of each node may include the addresses of the other two nodes.

707-708: At 707, in response to Node₂ receiving the KA(0) from Node₁ at 701, Node₂ adds the IP address of Node₁ to its IPL, increments its sequence number to IP_SQN_{node2}=1, and restarts the T_{purgeconfig} timer it keeps for Node₁ (i.e., if the address of Node₁ is in Node₂'s CCT). At 708, Node₂ replies to Node₁ with KA(1) message (i.e., K(IP_SQN_{node2}=1)) (e.g., see FIG. 4, processes 422-424).

709-710: Node₁ receives the KA(1) message from Node₂ at 709, and the IP_SQN_{Node1} is set equal to 1, i.e., the current IP_SQN_{Node2} (e.g., see process 446 of FIG. 4). Next, Node₁ initiates a learning procedure by sending an IPReq message to Node₂ (e.g., see FIG. 4, process 446), which causes Node₂ to respond with an IPRsp(IPL_{Node2}) message including its IPL information of Node₂. At 710, Node₁ learns the IPL of Node₂ (e.g., procedure 500 of FIG. 5) and stores the IP address of Node₂ in its IPL.

711-712: Node₂ receives a KA(0) message, at 706, from Node₃. At that time, IP_SQN=1 for Node₂ and IP_SQN=0 for Node₃. Accordingly, the IP address of Node₃ is added to the IPL of Node₂, the IP_SQN of Node₂ is incremented from 1 to 2 at 711, and at 712 Node₂ sends a KA(2) message to Node₃ (e.g., see process 422 of FIG. 4).

713-714: Because the IP_SQN=2 of Node₂ received at Node₃ is greater than the IP_SQN of Node₃, Node₃ sends an IPReq message to Node₂, and restarts the T_{purgeconfig} timer it keeps for Node₂ (e.g., see FIG. 4, processes 443 to 446). Node₂ responds with an IPRsp(IPL_{Node2}) message including its IPL information. Next, Node₃ performs a learn procedure at 714 and stores the IP addresses of Node₂ and Node₁ in its IPL (e.g., see FIG. 5, processes 510-524), and sets its IP_SQN equal to the value 2 at 713 (e.g., see FIG. 5, process 536).

715-716: Meanwhile, Node₁ had received the KA(0) message from Node₃ at 705, which caused Node₁ to store the IP address of Node₃ in the IPL of Node₁, increment its IP_SQN from 1 to 2 at 715, and send a KA(2) message to Node₃ at 716. However, because the IP_SQN's of Node₁ and Node₃ have equal values, and Node₃ currently includes the address of Node₁ in its IPL, the IP_SQN and IPL of Node₃ remain unchanged and the T_{purgeconfig} for Node 1 kept by Node 3 is restarted (e.g., see FIG. 4, processes 432, 435 and 436).

All node IPLs are now synchronized at IP_SQN=2 (in this case, the CCT is equal to the IPL for each node). At this equilibrium or steady state, the remaining KAs are ignored except for restarting T_{purgeconfig} timers for remote nodes.

Discovery of Nodes Entering Community

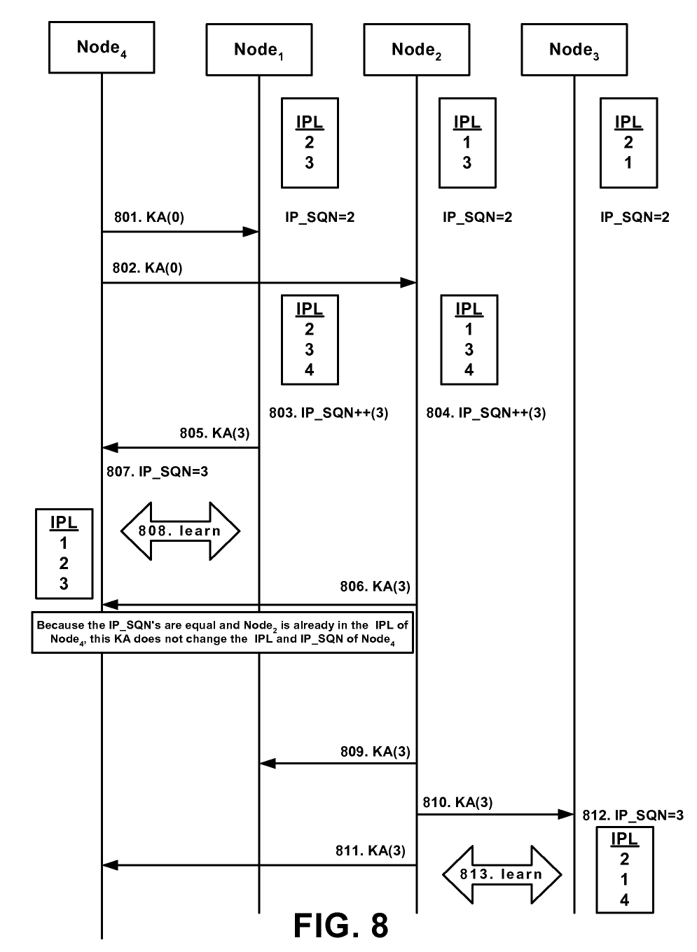

FIG. 8 shows how the automatic discovery protocol operates when a node enters an existing community. The initial state of Node₁, Node₂ and Node₃ depicted in FIG. 8 is similar to an equilibrium state reached after a concurrent start, such as described in connection with the embodiment depicted in FIG. 7. While the community is in an equilibrium state, Node₄ is turned on and begins to broadcast KA(0) messages to other nodes systems. However, Node₄ does not send a KA(0) to Node₃ because the SL and CBL of the Node₄ system have not been configured to include Node₃. For example, Node₄ may have been seeded with the addresses of nodes (4+1)MOD(4)=1 and (4+2)MOD(4)=2. The detailed implementation of the network automatic discovery protocol may proceed as follows:

801-802: The Node₄ sends a KA(0) to the node systems in its SL (i.e., Node₁ and Node₂).

803-806: Upon receipt of the KA(0)'s, each of Node₁ and Node₂ add the IP address of Node₄ to their respective IPL's, increment their respective IP_SQN's to 3 at 803 and 804, and reply with a KA(3) to Node₄ at 805 and 806. (See, FIG. 4, process 422.) At this time, each of Node₁ and Node₂ start T_{purgeconfig} timers associated with Node₄.

807-808: After receiving the KA(3) from Node₁, at 807 the IP_SQN of Node₄ is set equal to the value of the IP_SQN of Node₁, and Node₄ sends an IPReq to Node₁. (See, FIG. 4, process 446.) Thereafter, Node₁ replies at 808 with its IPL information and initiates learning procedure (e.g., procedure 400 of FIG. 4), which adds the IP address of Node₁ to the IPL of Node₄ as well as the IP addresses of Node₂ and Node₃. In response to receiving the KA(3) at 806, the Node₄ restarts the T_{purgeconfig} timer for Node₂.

809-811: At the timeout of the T_{KeepAlive} timer, Node₂ broadcasts a KA(3) message to all the remote nodes in the community, namely, Node₁, Node₃ and Node₄, at 809, 810 and 811, respectively. While Node₂ broadcasts its KA(3) to all the remote nodes in the community, only Node₃ will learn the new IPL from Node₂ due to different IP_SQN.

812-813: Node 3 learns about the Node₄ through the KA(3) at 810. At the time this KA is received, the UP_SQN of Node₃ is 2, and thus less than the IP_SQN of Node₂. In this case, Node₃ restarts the T_{purgeconfig} timer for Node₂, sets the IP_SQN of Node₃ equal to the IP_SQN of Node₂ (i.e., 3), and initiates a learn procedure (e.g., procedure 500 of FIG. 5) by sending an IPReq message to Node₂ to obtain IPL information of that node. In response, the Node₂ sends an IPRsp including its IPL information to Node₃, and Node₃ adds the IP address of Node₂ to its IPL as well as the IP addresses of Node₁ and Node₄.

Thus, when Node₄ joins the community, it sees Node₁'s Keep Alive message and updates its sequence number IP_SQN. Since Node₄ does not have complete knowledge of the database of the community, it asks Node₁ for the entire contents of its IPL. After the transfer is complete, Node₄ has the database of the entire community without having to request it individually from every system in the community. All node systems become synchronized to a new IP_SQN and continue to exchange periodic Keep Alive messages.

Discovery of Nodes Leaving a Community

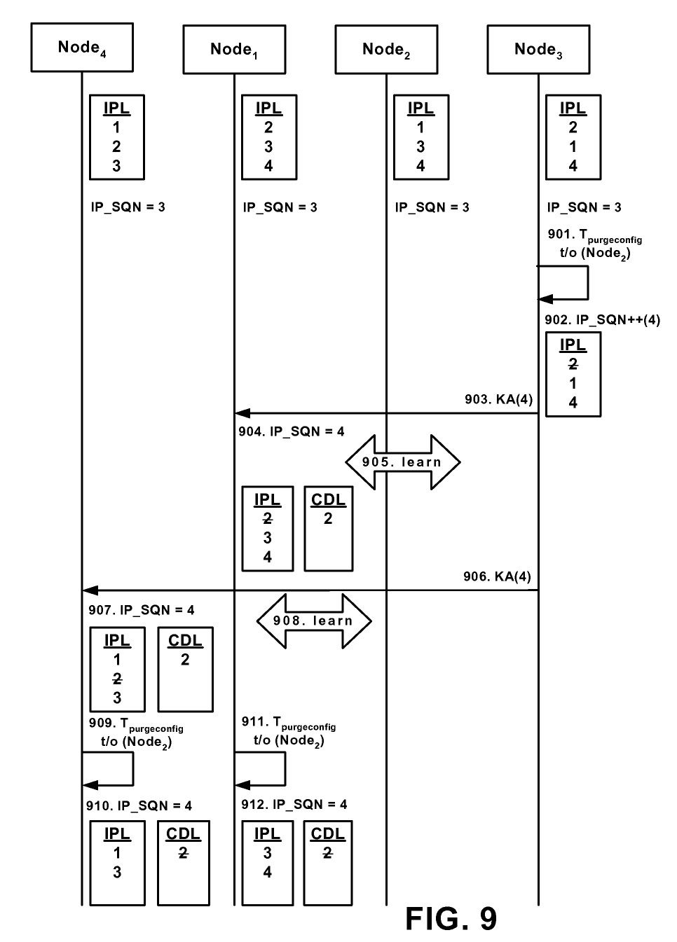

FIG. 9 illustrates how the discovery protocol addresses situations in which a node leaves a community according to some embodiments. The community of FIG. 9 includes four nodes, Node₁ to Node₄, each having an initial state similar to a state reached after a concurrent, quasi-simultaneous start, or some other start scenario, such as a nodes joining one-by-one.

The sequence number of each node has the same value, IP_SQN=3, at the time a T_{purgeconfig} timer for Node₂ kept by Node₃ expires or reaches timeout (t/o), indicating to Node₃ that Node₂ has left the community. The remaining nodes may discover this change as follows:

901-906: At 901, Node₃ 's T_{purgeconfig} timer for Node₂ expires, which causes Node₃ to remove the IP address of Node₂ from its IPL, increment its IP_SQN to the value 4 at 902 (e.g., see processes 620, 630 and 640 in FIG. 6), and at timeout of its T_{KeepAlive}, sends KA(4) messages 903 and 906 to respective remaining nodes Node₁ and Node₄. At 904, Node₁ determines that Node₃ has incremented its IP_SQN to a value greater than its own IP_SQN and sends an IPReq message to Node₃ requesting Node₃'s IPL information. Node₃ replies with its IPL information while Node₁ performs a learn procedure at 905 and moves the IP address of Node₂ from its IPL to its CDL.

907-908: After Node₄ receives the KA(4) at 906, Node₄ sets its IP_SQN equal to the value of the IP_SQN of Node₃ at 907, and updates its IPL and CDL at 908 in a manner similar to the learn procedure performed by Node₁ at 905.

909-912: At 909 and 911, Node₄ and Node₁ respectively have a T_{purgeconfig} timeout of Node₂, and they both remove Node₂ from their respective CDL's and retain their IP_SQN value (e.g., see FIG. 6, procedures 620 and 650). Thus, the remaining nodes are synchronized to a new value IP_SQN=4, IPL, and continue to exchange periodic Keep Alive messages.

In other scenarios, more than one T_{purgeconfig} timers kept by a node may timeout concurrently, substantially the same time, consecutively, or T_{purgeconfig} timers kept among the nodes in a community may timeout similarly or in various orders. However, the community will eventually reach an equilibrium state in each of these scenarios. In addition, even if all T_{purgeconfig} timers corresponding to remote node addresses in the CCT of a local node timeout, the local node may continue to function and provide service as a stand-alone node.

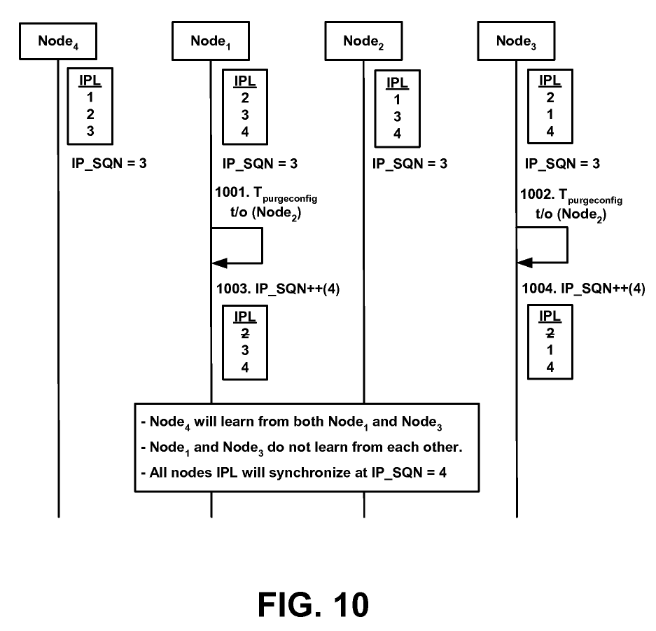

FIG. 10 illustrates a scenario in which a concurrent or quasi-concurrent T_{purgeconfig} timeout occurs in two or more nodes with respect to a same node. At 1001 and 1002, Node₁ and Node₃ respectively detect a T_{purgeconfig} timeout of Node₂. Node₁ and Node₃ each removes the IP address of Node₂ from its IPL and increments its IP_SQN value, respectively at 1003 and 1004. After the next T_{KeepAlive} timeouts (not shown), Node₄ will learn from both Node₁ and Node₃ because its IP_SQN is less than that of Node₁ and Node₃. However, because Node₁ and Node₃ have the same IP_SQN value, they do not learn from each other. The IPLs of Node₁, Node₂ and Node₄ will synchronize at IP_SQN=4.

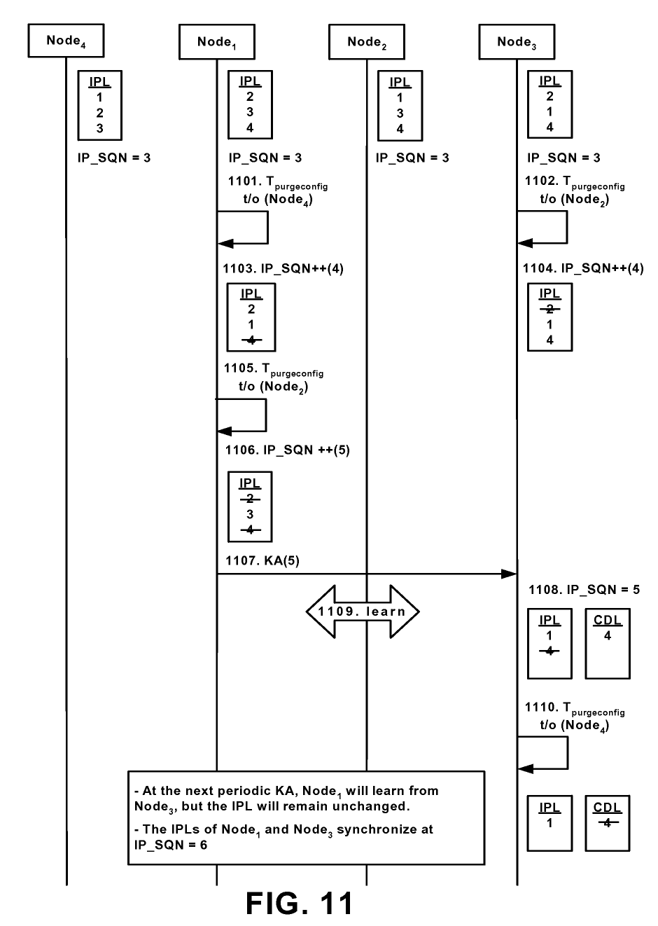

FIG. 11 illustrates an exemplary scenario in which concurrent or quasi-concurrent T_{purgeconfig} timeouts of different nodes occur at a plurality of node systems. Discovery of these nodes leaving the community proceeds as follows:

1101-1106: As shown in FIG. 11, Node₁ detects a T_{purgeconfig} timeout for Node₄ at 1101, and Node₃ detects a T_{purgeconfig} timeout for Node₂ at 1102. Accordingly, Node₁ removes the IP address of Node₄ from its IPL and increments its IP_SQN at 1103, and Node₃ removes the IP address of Node₂ from its IPL and increments its IP_SQN at 1104. Next, at 1105, Node₁ detects a T_{purgeconfig} timeout for Node₂ and removes the IP address of Node₂ from its IPL and again increments its IP_SQN at 1106.

1107-1009: At 1107, Node₁ sends out a periodic Keep Alive message (KA(5)) to Node₃. After Node₃ receives the KA message, at 1108 it sets its IP_SQN value equal to the IP_SQN of Node₁. Next, Node₃ conducts a learning process at 1109 via exchanges IPReq/IPRsp messages in a learn procedure, which moves the IP address of Node₄ from its IPL to its CDL.

1110: Node₃ detects a T_{purgeconfig} timeout for Node₄ at 1110, which results in Node₃ removing Node₄ from its CDL. At the next periodic KA, Node₁ will learn from Node₃, but the IPL of Node₁ will remain unchanged. The IPLs of Node₁ and Node₃ will synchronize at IP_SQN=6.

Discovery During Link Down and Recovery

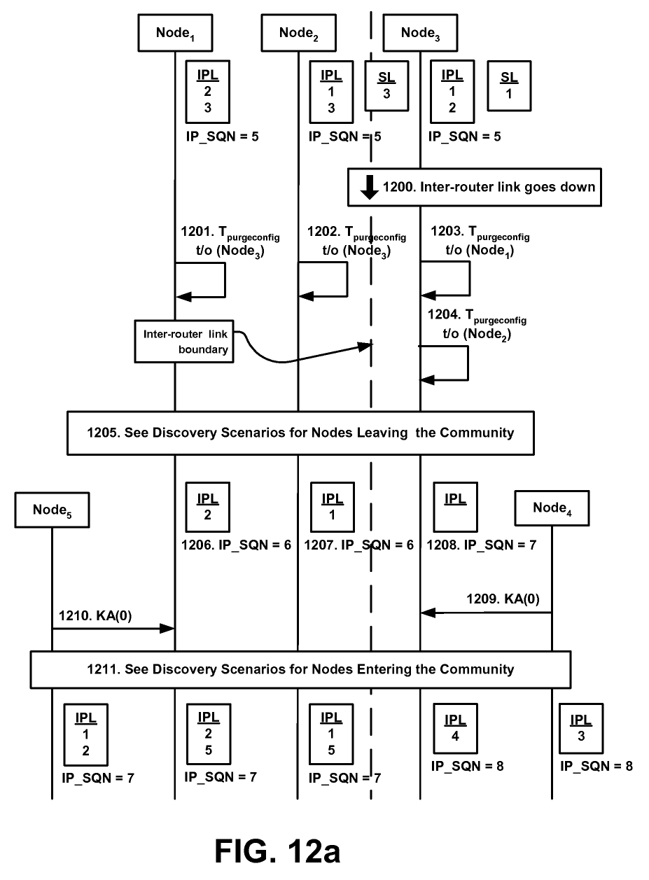

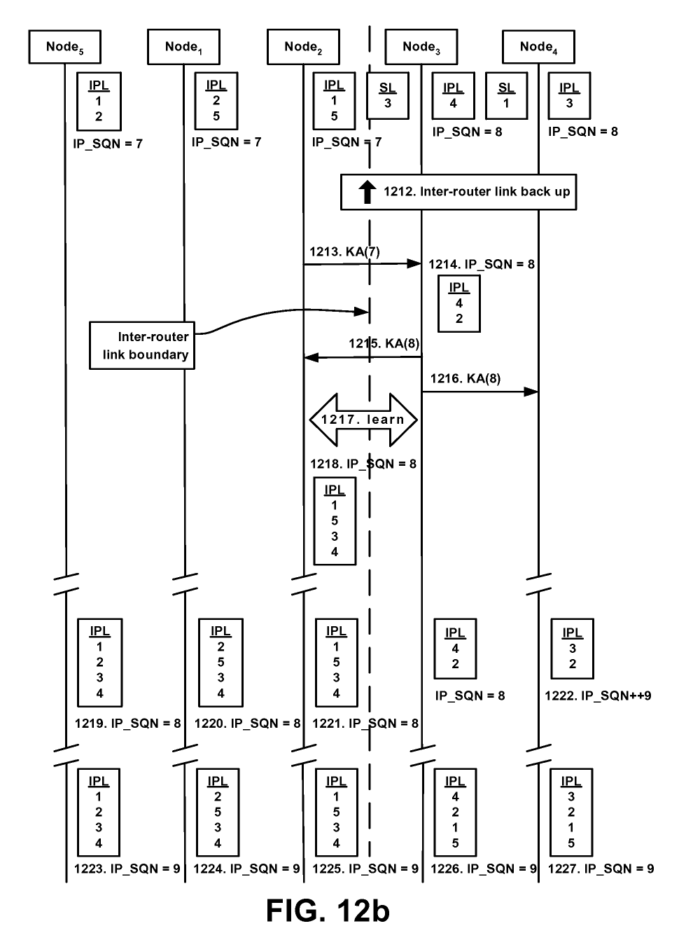

FIG. 12a is a diagram illustrating an exemplary scenario in which an inter-router link connecting groups of nodes in a community fails or otherwise goes down, but node groups existing on either side of the failed link may still communicate among themselves, as well as discover newly added nodes, and synchronize to these new conditions. FIG. 12b is a continuation of FIG. 12a and illustrates rediscovery of the nodes lost at the time the link went down, and discovery of any links added during down time, after the failed link is restored.

As shown in FIG. 12a, a community including Node₁, Node₂ and Node₃ are synchronized at IP_SQN=5. Node₂ has a SL including the IP address of Node₃, and Node₃ has a SL including the IP address of Node₁. The dashed line depicted between Node₂ and Node₃ represents an inter-router link boundary over which Node₁ and Node₂ communicate with Node₃, and vice versa. At 1200, the inter-router link goes down, thus interrupting communication between the nodes on either sides of the downed link. Discovery in this scenario may proceed as follows:

1201-1204: Each of Node₁ and Node₂ detects a T_{purgeconfig} timeout for Node₃ at 1201 and 1202, respectively, and Node₃ detects T_{purgeconfig} timeouts for Node₁ and Node₂ at 1203 and 1204, respectively.

1205-1208: As described previously herein, a T_{purgeconfig} timeout of a remote node system detected at a local node system may involve removing the IP address of the remote node from the IPL of the local node and incrementing the local node's IP_SQN (e.g., see FIG. 5). Accordingly, Node₁ and Node₂ remove the address of Node₃ from their IPLs and increments their sequence numbers to IP_SQN=6 at 1206 and 1207, and Node₃ removes the addresses of Node₁ and Node₂ from its IPL, each time incrementing its sequence number to IP_SQN=7 at 1208.

1209-1211: Node₄ enter the community with the transmission of Keep Alive (K(0)) messages at 1209, and Node₅ also enters and sends a KA(0) to Node₃ at 1210. It is to be appreciated that the entering nodes may send more than one Keep Alive message if, for example, their SL's contain additional addresses. At 1211, the Node₁ and Node₃ add the IP addresses of Node₅ and Node₄ to their respective IPL's, increment their IP_SQN's to the values 7 and 8, respectively, and reply with a with KA's to the entering nodes. Because the entering Node₅ and Node₄ have IP_SQN values less than the IP_SQN values of the KA sending nodes Node₁ and Node₃, the IP_SQN's of Node₁ and Node₃ will be set equal to the IP_SQN's of Node₁ and Node₃, respectively, and Node₅ and Node₄ will learn the addresses of the respective KA senders and the addresses in their IPL's. At the T_{KeepAlive} timeout, Node₁ broadcasts a KA(7) to Node₅ and Node₂ will learn the new IPL from Node₁. Node₄ similarly updates its IP_SQN to the value of Node₃ IP_SQN and thereafter learns the IP address and IPL of Node₃.

Referring now to FIG. 12b (the initial states after synchronization of Node₁ to Node₃, and Node₃ and Node₄ after the link went down are shown at the top of the diagram) at 1212, the inter-router link is restored, and the KA messages that are sent repeatedly according to addresses in the SL are received. This illustrates the usefulness of using a SL in parallel with the CBL for such a scenario. The discovery may proceed as follows:

1213-1218: At the next T_{KeepAlive}, Node₂ sends a KA(7) to Node₃. Because the IP_SQN of Node₂ is less than Node₃, Node₃ will simply add the IP address of Node₂ to its IPL (i.e., at 1214 the IP_SQN is not incremented) and leave Node₂ to learn its IPL at the next KA of Node₃ at 1215, 1217 and 1218. The K(8) at 1216 is ignored except for restarting the T_{purgeconfig} timer kept for Node₃ at Node₄.

1219-1222: At the next timer expiry of T_{KeepAlive} in Node₂, Node₅ and Node₁ (currently at IP_SQN=7) sets their IP_SQN=8 and learn from Node₂ at 1219 and 1220, respectively; Node₄ adds Node₂ as an IPL entry because they have equal IP_SQN and increments its IP_SQN=9 at 1222.

1223-1227: The next timer expiry of T_{KeepAlive} in Node₂ and Node₅ will see Node₃ and Node₄, add both former entries to their IPL and completely synchronize the community. Due to unequal IP_SQN values, there will be three more learning sessions (by Node₁, Node₂ and Node₅); however, because the IPL's of Node₁, Node₂ and Node₅ are complete, this will only serve to equalize the IP_SQN throughout the community.

The auto discovery protocol described herein provides robustness by maintaining link status information of community members and detecting when other community members enter or leave the community. The protocol maintains a sequence number at each node that indicates a change in state to other nodes in the community; and seed list that provides both an initial list of community members to advertising its presence at startup as well as a mechanism to recover when communication is interrupted.

It will be apparent to those skilled in the art that various changes and modifications can be made in the network automatic discovery protocols and configurations of the present invention without departing from the spirit and scope thereof. Thus, it is intended that the present invention cover the modifications of this invention provided they come within the scope of the appended claims and their equivalents.

What is claimed is:

1. A method for node discovery in a network performed by each of a plurality of network nodes linked in the network, comprising:
maintaining, at a network node, a member list containing at least a subset of addresses of the plurality of network nodes, a sequence value, and an active address list;
repeatedly transmitting to each address in the member list a presence message including an address of the network node and the sequence value;
receiving a presence message from a remote network node, said received presence message including an address of that remote network node and a sequence value of the remote network node; and
if the received sequence value is equal to a predetermined initial value and the remote network node address is not stored in the active address list of the network node, the address of the remote network node is stored in the active address list of the network node, the sequence value of the network node is incremented, and a presence message containing the incremented sequence value is transmitted to the remote network node; or
if the sequence value of the network node is greater than or equal to the sequence value of the remote network node, and the address of the remote network node is not stored in the active address list of the network node, the address of the remote network node is stored in the active address list of the network node; or
if the sequence value of the network node is less than the sequence value of the remote network node, the sequence value of the network node is set equal to sequence value of the remote network node, content of an active address list maintained at the remote network node is requested, and the active address list of the network node is updated with said content.

2. The method of claim 1, further comprising:
maintaining a timer that automatically resets after a predetermined period of time, and each said presence message is transmitted after each reset of the timer.

3. The method of claim 1, further comprising:
associating each address stored in said member list of the network node with a respective purge timer.

4. The method of claim 3, wherein if a purge timer associated with a remote network node address stored in the active list expires, the address of the associated remote network node is removed from the active address list.

5. The method of claim 3, wherein the purge timer associated with a remote network node address is restarted each time a presence message is received from that remote network node and if the remote network node address is stored in the member list.

6. The method of claim 3, further comprising:
incrementing the sequence value of the network node after expiry of any purge timer associated with a remote network node address stored in the active address list of the network node.

7. The method of claim 6, wherein the network node maintains a candidate deletion list, and said updating further comprises:
moving any address stored in the active list of the network node that is not also contained in the received message to the candidate deletion list.

8. The method of claim 1, wherein updating said active address list of the network node with said content comprises:
receiving a message containing each address stored in the active address list of the remote network node in response to the request, and
storing any received address in the active address list of the network node if not already stored therein.

9. The method of claim 1, wherein if the sequence value of the network node is greater than or equal to the sequence value of the remote network node, the sequence value is incremented.

10. The method of claim 1, wherein if the sequence value of the network node is greater than or equal to the sequence value of the remote network node, and the address of the remote network node is not stored in the active address list, the method further comprises:
incrementing the sequence value of the network node.

11. A method of discovery in a network, comprising:
repeatedly sending a presence message from a local network node to at least one remote network node identified in a member list provided at the local network node, each said presence message including data identifying the local network node and a data value indicating an amount of topology change discovered by the local network node;
receiving, at the local network node, a presence message sent by a remote network node including data identifying the remote network node and a data value indicating an amount of topology change discovered by the remote network node;
determining whether the data identifying the remote network node is absent from an active node list maintained at the local network node, and if so:
a) if the received data value indicates no topology change:
1) storing the data identifying the remote network node in the active node list,
2) adjusting the data value of the local network node to indicate a greater amount of discovered topology change, and
3) replying to the remote network node with an updated presence message including the adjusted data value; or
b) if the received data value indicates an amount of topology change less than the amount indicated by the received data value:
1) adjusting the data value of the local network node to equal the data value of the remote network node, and
2) sending a request from the local network node to the remote network node for an active node list maintained at the remote network node; or
c) if the local network node data value indicates an amount of topology change greater than or equal to the received data value:
1) storing the data identifying the remote network node in the active node list at the local network node, and
2) adjusting the data value of the local network node to indicate a greater amount of discovered topology change.

12. The method of claim 11, wherein the local network node includes a presence message timer that periodically resets, and after each said reset, said presence message is transmitted from the local network node to each remote network node identified in the member list.

13. The method of claim 11, further comprising:
associating data identifying each remote network node stored in member list with a respective purge timer, wherein the identifying data of a remote network node is removed from the active node list of the local network node if the associated purge timer expires.

14. The method of claim 13, wherein a purge timer associated with a remote network node is restarted if a presence message is received from that remote network node, and data identifying that remote network node is stored in the active node list of the local network.

15. The method of claim 13, further comprising adjusting the data value of the local network node to indicate a greater amount of discovered topology change after expiry of any purge timer associated with remote network node identifying data stored in the active node list.

16. The method of claim 11, further comprising:
maintaining a candidate deletion list at the local network node for storing any addresses removed from the active node list of the local network node.

17. The method of claim 11, wherein in response to sending the request for an active node list maintained at the remote network node, the local network node receives a message containing node-identifying data stored in the active node list of the remote network node, and the local network node stores in the active node list the received node-identifying data not already stored in the active node list of the local network node.

18. The method of claim 17, wherein the local network node maintains a candidate deletion list, and the method further comprises:
moving to the candidate deletion list any node-identifying data stored in the active node list of the local network node that is not also contained in the received message.
